(19) United States
(12) Patent Application Publication
(10) Pub. No.: US 2025/0074243 A1
(43) Pub. Date: Mar. 6, 2025

(54) OBSERVER SYSTEM FOR PASSIVE PARAMETERS IDENTIFICATION AND ADAPTIVE CONTROL ALGORITHM IN BI-DIRECTIONAL EV CHARGING SYSTEMS

(71) Applicant: Qatar Foundation for Education, Science and Community Development, Doha (QA)

(72) Inventors: Haitham Abu-Rub, Doha (QA); Ali Sharida, Doha (QA); Sertac Bayhan, Doha (QA)

(21) Appl. No.: 18/817,747

(22) Filed: Aug. 28, 2024

Related U.S. Application Data
(60) Provisional application No. 63/534,924, filed on Aug. 28, 2023.

(51) Int. Cl. B60L 53/62; B60L 55/00; H02J 3/32

(52) U.S. Cl. CPC B60L 53/62; B60L 55/00; H02J 3/322

(57) ABSTRACT

A system includes an observer configured to estimate passive components parameters based on digital twin, where the observer is designed based on a dynamic response difference between a physical system and the digital twin. The observer is configured to estimate a lumped disturbance vector (LDV) comprising one or more parameter changes, the one or more parameter changes are caused when i) a resistance variation changes a grid currents to DC link voltage ratio in the physical system; ii) DC side capacitors change a transient time of a DC link voltage, and/or iii) inductors change a transient time of grid currents.

### RELATED APPLICATIONS

This application claims the benefit of and priority to U.S. Provisional Patent Application No. 63/534,924, filed Aug. 28, 2023, entitled “OBSERVER SYSTEM FOR PASSIVE PARAMETERS IDENTIFICATION AND ADAPTIVE CONTROL ALGORITHM IN BI-DIRECTIONAL EV BATTERY MANAGEMENT SYSTEM,” incorporated herein by reference in its entirety.

### BACKGROUND

Modern smart converters are widely used in smart grid industrial applications all around the world. The loads and devices connected to the grid become smarter each day, such as electric vehicles (EV). EVs will become key elements in supporting electric grid stability, the integrity of which has been tested in certain areas in recent years. The development of the load smart and flexible profile is combined with the development of proper control which may include adaptive and robust observers. Moreover, the applications of vehicle-to-grid (V2G) and grid-to-vehicle (G2V) have become crucial for a stable and robust futuristic grid. However, many challenges exist in such applications including generation uncertainty, disturbances, sudden load change, and sudden change in the direction of power flow.

For passive components parameters estimation, an analytical-based approach has been proposed to estimate the unknown parameters for a single-phase uncontrolled rectifier. Despite that, it is easy to predict the behavior of the voltage in an uncontrolled rectifier, the prediction is more complex in AFR's where many parameters affect the voltage behavior rather than the passive components.

A method for estimating the inductance of the input filter has been proposed based on the model reference and adaptive system observers. This method requires two independent models, a reference model based on the measured currents, while the other one is an adaptive estimated model that depends on the inductance value. Comparing these models can be used to estimate the value of the filter's inductance. However, having two independent models to estimate a single parameter is not efficient and time-consuming.

A load resistance estimation method has also been proposed for the electric vehicle rectifier system. The load estimation method was based on the dual-active bridge secondary side high-frequency voltages. However, it is difficult to acquire data from high-frequency voltage using a low-cost microcontroller. Goertzel Algorithm (GA) was used to estimate the passive components parameters on the DC link side including the capacitance. The estimated values were used to compensate for their effects at the DC side and as an indicator of capacitors' degradation. However, GA suffers mainly from inaccuracy generated by rounding frequencies to the nearest integer multiples.

As a result, a reliable and consistent observer system for passive parameters identification and adaptive control is needed in smart load devices such as bi-directional EV charging.

### SUMMARY

The present disclosure generally relates to an observer system for passive parameters identification and adaptive control algorithm for bi-directional EV charging systems.

In light of the present disclosure, and without limiting the scope of the disclosure in any way, in an aspect of the present disclosure, which may be combined with any other aspect listed herein unless specified otherwise, a system includes an observer configured to estimate passive components parameters based on digital twin, where the observer is designed based on a dynamic response difference between a physical system and the digital twin. The observer is configured to estimate a lumped disturbance vector (LDV) comprising one or more parameters changes, where the effects of these changes can be summarized as follows: i) the load variation changes the grid currents to DC link voltage ratio in the physical system; ii) DC side capacitance variation changes the transient time of the DC link voltage, and/or iii) inductance variation changes the transient time of the DC link voltage.

In an aspect of the present disclosure, which may be combined with any other aspect listed herein unless specified otherwise, the system further includes an automatic gains tuner configured to receive the LDV to select the optimal gains of the controller to achieve a predefined response.

In an aspect of the present disclosure, which may be combined with any other aspect listed herein unless specified otherwise, the system further includes an adaptive controller configured to achieve the predefined response after the LDV is estimated and the gains are tuned.

The reader will appreciate the foregoing details, as well as others, upon considering the following detailed description of certain non-limiting embodiments including an observer system for passive parameters identification and adaptive control algorithm in bi-directional EV battery management system according to the present disclosure.

### BRIEF DESCRIPTION OF THE FIGURES

FIG. 1 shows a schematic diagram according to the present disclosure.

### DETAILED DESCRIPTION

The present disclosure generally relates to an observer system for passive parameters identification and adaptive control algorithm for bi-directional EV charging systems.

Aspects of the present disclosure may address the above discussed issues in the related art, for example, by using a DT-based observer, where the DT-based observer is capable of estimating the load resistance, DC side capacitance, and input/output filter inductance. Moreover, the observer according to the present disclosure may be simple, reliable, applicable for industrial applications that depend on low-cost microcontrollers, and may have many other advantages.

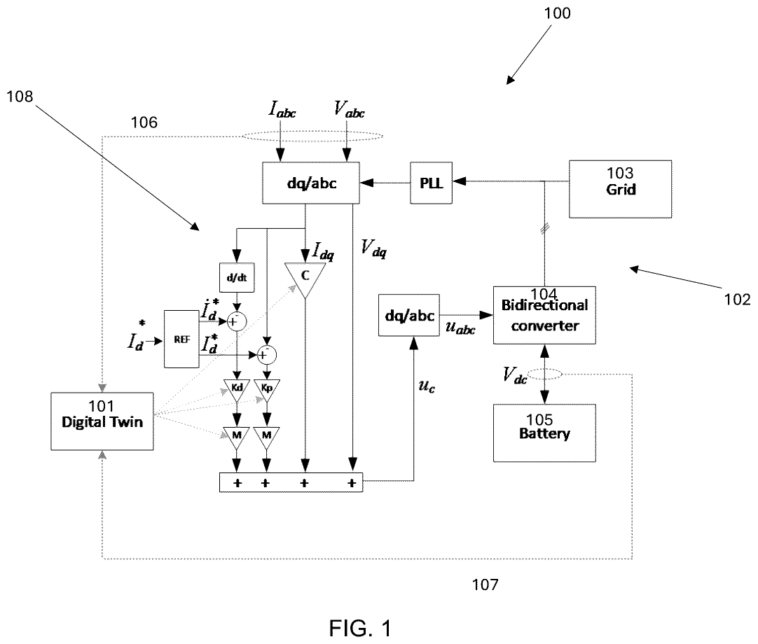

With reference to FIG. 1 as an example, the observer 100 according to the present disclosure may be provided for passive components parameters estimation which is based on a digital twin 101. The observer may be designed based on the dynamic response difference between the physical system 102 and its digital twin as follows: i) the resistance variation may change the grid currents to DC link voltage ratio in the physical system, ii) DC side capacitors may change (increase/decrease) the transient time of the DC link voltage, and iii) the inductors may change (increase/decrease) the transient time of grid currents, these changes may be considered as a lumped disturbance vector (LDV) and estimated online using the observer 100.

The LDV may be fed to an automatic gains tuner 108 to adapt the gains of the controller to achieve a predefined response. As the LDV is estimated accurately and the gains are tuned, an adaptive controller may be used to achieve the predefined response. The controller may depend on the inverse dynamics of the physical system, in addition to a PD controller to eliminate the tracking error. One of the main advantages of the proposed controller is its ability to perform a sixth-order dynamic trajectory in tracking the grid currents. This may make the direction changes in power flow smooth, fast, accurate, and can completely eliminate the overshoots at the instant when the operation of the converter is changed from inverter to rectifier.

In some examples, a system according to the present disclosure may include a digital twin 101 for a three-phase inverter/rectifier, a passive components observer, an online gains tuner, and/or a robust and adaptive inverse dynamics control algorithm. These algorithms may be implemented and applied for smart EV charging apparatus that may support both V2G and G2V.

In some examples, a method may include the design and implementation of a novel passive parameters observer and a robust inverse dynamics control algorithm that depends on a sixth-order current trajectory generation to ensure smooth, fast, accurate, and reliable tracking of a reference current signal.

The system and/or method according to the present disclosure may be unique because i) it involves a novel passive parameter observer, a novel gain tuning algorithm, a novel adaptive and robust control algorithm, ii) may be applicable for industrial applications that exposed to uncertainties and disturbances and applicable for low-cost microcontrollers, and iii) may adaptively control the process of EV charging and grid supporting.

In some examples, the system/method/algorithms according to the present disclosure can be used for smart management of EV battery charging and control power flow direction. The system/method/algorithms according to the present disclosure can be further used by engineers, researchers, and industry to perform real-time and reliable control, V2G function, G2V function, reliable management and control of power flow direction, and many other functions and applications.

Aspects of the present disclosure may advantageously provide a system/method with higher reliability, robustness against passive parameters change, robustness against disturbances and grid abnormal conditions (such as voltage distortion, unbalanced grid voltages, and voltage sag and swell), low computation requirements, smooth, fast, accurate, and real-time response, while it is applicable for low-cost microcontrollers and there is no need for initialization or manual parameters tuning.

In an illustrative example, a home charging port for an electric vehicle includes the observer 100. A bidirectional converter 104 acts as a conduit between the battery 105 of the electric vehicle and the grid 103, which may be a microgrid of the household or a larger grid. In one embodiment, the grid 103 is a household grid. The observer 100 may be implemented on a microcontroller housed at or near the home charging port, and employs the digital twin 101 which receives inputs 106, 107. The microcontroller performs sixth-order dynamic trajectory in tracking the grid currents using the digital twin 101 and implements a dynamic plan to the automatic gains tuner 108. In this way, if a power surge is detected, the model may implement a plan to have the bidirectional converter 104 return power to the grid 103, or may stabilize the power from the grid 103 to the battery 105 by adjusting the parameters of the automatic gains tuner 108. In this way the household is ensured a proper power supply when the electric vehicle is not being used, while also supporting proper charging of the electric vehicle. This system is not limited to the example of a microgrid at a household, but rather could be implemented at a commercial facility that has EV charging ports, or more generally to a city-wide or larger grid consisting of a multitude of EV charging ports at commercial and/or household locations depending on the expediencies of the grid.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system comprising:
an observer configured to estimate passive components parameters based on digital twin, wherein the observer is designed based on a dynamic response difference between a physical system and the digital twin, wherein the observer is configured to estimate a lumped disturbance vector (LDV) comprising one or more parameter changes, the one or more parameter changes are caused when:
i) a resistance variation changes a grid current to DC link voltage ratio in the physical system,
ii) DC side capacitors change a transient time of a DC link voltage, or
iii) inductors change a transient time of grid currents.

2. The system of claim 1, further comprising: an automatic gains tuner configured to receive the LDV to adapt gains of a controller to achieve a predefined response.

3. The system of claim 2, further comprising: an adaptive controller configured to achieve the predefined response after the LDV is estimated and the gains are tuned.

4. The system of claim 1, wherein the controller depends on the inverse dynamics of the physical system.

5. The system of claim 4, further including a PD controller configured to eliminate a tracking error.

6. The system of claim 1, wherein the observer implements an inverse dynamics control algorithm that depends on a sixth-order current trajectory generation.

7. The system of claim 1, wherein the observer is implemented on an EV charging apparatus.

8. The system of claim 7, wherein the EV charging apparatus supports both vehicle-to-grid and grid-to-vehicle energy transfer.

9. The system of claim 8, wherein the observer is used in determining the direction of energy flow through a bidirectional converter between the grid and a battery of at least one electric vehicle.

10. The system of claim 9, wherein the observer is implemented on a household microgrid and electric vehicle charging port.
